(19) United States
(12) Patent Application Publication
(10) Pub. No.: US 2025/0389231 A1
(43) Pub. Date: Dec. 25, 2025

(54) FUEL SYSTEMS FOR GAS TURBINE ENGINES

(71) Applicants: General Electric Company, Schenectady, NY (US); GE Avio S.r.l., Turin (IT)

(72) Inventors: Eyitayo James Owoeye, Houston, TX (US); Mirko Gernone, Noicattaro (IT)

(21) Appl. No.: 18/640,054

(22) Filed: Apr. 19, 2024

(51) Int. Cl. F02C 9/28; B64D 37/34; F02C 7/14; F02C 7/22; F02C 7/224

(52) U.S. Cl. CPC F02C 9/28; B64D 37/34; F02C 7/14; F02C 7/22; F02C 7/224; F05D 2260/213

(57) ABSTRACT

A fuel system for a gas turbine engine including a compressor section, a combustion section, and a turbine section includes a fuel tank for storing a fuel, a plurality of heat exchangers downstream of the fuel tank, and a valve downstream of the plurality of heat exchangers. The valve includes a fuel inlet in fluid communication with the plurality of heat exchangers, a first fuel outlet in fluid communication with a first fluid pathway, and a second fuel outlet in fluid communication with a second fluid pathway. The fuel system includes a fuel cell including an anode inlet and an anode outlet. The anode inlet is in fluid communication with the first fluid pathway. The fuel system also includes a combustion chamber of the combustion section in fluid communication with the second fluid pathway and the anode outlet of the fuel cell and a controller communicatively coupled to the valve.

### FIELD

The present disclosure relates to fuel systems for gas turbine engines.

### BACKGROUND

A gas turbine engine generally includes a turbomachine and a rotor assembly. Gas turbine engines, such as turbofan engines, may be used for aircraft propulsion. In the case of a turbofan engine, the turbomachine includes a compressor section, a combustion section, and a turbine section in serial flow order, and the rotor assembly is configured as a fan assembly.

During operation, air is compressed in the compressor and mixed with fuel and ignited in the combustion section for generating combustion gases which flow downstream through the turbine section. The turbine section extracts energy therefrom for rotating the compressor section and fan assembly to power the gas turbine engine and propel an aircraft incorporating such a gas turbine engine in flight.

Improvements in emissions from conventional gas turbine engines may be improved by utilizing hydrogen fuel. Accordingly, fuel systems for facilitating the use of hydrogen fuel in gas turbine engines are desirable.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an aircraft having a fuel system in accordance with an exemplary embodiment of the present disclosure.

FIG. 2 is a schematic cross-sectional view of a gas turbine engine according to an exemplary embodiment of the present disclosure.

FIG. 3 is a schematic diagram of a fuel system of the gas turbine engine of FIG. 2 according to an exemplary embodiment of the present disclosure.

FIG. 4 is a flow chart of a method of operating the fuel system of FIG. 3 according to an exemplary embodiment of the present disclosure.

FIG. 5 is a schematic diagram of a fuel system of the gas turbine engine of FIG. 2 according to an exemplary embodiment of the present disclosure.

FIG. 6 is a schematic diagram of a fuel system of the gas turbine engine of FIG. 2 according to an exemplary embodiment of the present disclosure.

FIG. 7 is a schematic diagram of a fuel system of the gas turbine engine of FIG. 2 according to an exemplary embodiment of the present disclosure.

FIG. 8 is a flow chart of a method of operating the fuel system of FIG. 7 according to an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise.

The term “at least one of” in the context of, e.g., “at least one of A, B, and C” refers to only A, only B, only C, or any combination of A, B, and C.

The term “turbine engine” refers to an engine having a turbomachine as all or a portion of its power source. Example turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

As used herein, a “bypass ratio” of a turbine engine is a ratio of bypass air through a bypass of the turbine engine to core air through a core inlet of a turbomachine of the turbine engine. For example, the bypass ratio is a ratio of bypass air 62 entering the bypass airflow passage 56 to core air 64 entering the turbomachine 160.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first,” “second,” and “third” may be used interchangeably to distinguish one component from another and are not intended to signify location or importance of the individual components.

For purposes of the description hereinafter, the terms “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The term “adjacent” as used herein with reference to two walls and/or surfaces refers to the two walls and/or surfaces contacting one another, or the two walls and/or surfaces being separated only by one or more nonstructural layers and the two walls and/or surfaces and the one or more nonstructural layers being in a serial contact relationship (i.e., a first wall/surface contacting the one or more nonstructural layers, and the one or more nonstructural layers contacting a second wall/surface).

As will be discussed in more detail below, fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. To improve system efficiency and fuel utilization and reduce external water usage, the fuel cell system may include an anode recirculation loop. As a single fuel cell can only generate about 1V voltage, a plurality of fuel cells may be stacked together (which may be referred to as a fuel cell stack) to generate a desired voltage. Fuel cells may include Solid Oxide Fuel Cells (SOFC), Molten Carbonate Fuel Cells (MCFC), Phosphoric Acid Fuel Cells (PAFC), and Proton Exchange Membrane Fuel Cells (PEMFC), all generally named after their respective electrolytes. Each of these fuel cells may have specific benefits in the form of a preferred operating temperature range, power generation capability, efficiency, etc.

The present disclosure is generally related to fuel systems for gas turbine engines utilizing cryogenic fuel. Utilization of cryogenic fuel, and in particular hydrogen fuel, to power a propulsion system of an aeronautical vehicle may provide many benefits, such as improved fuel efficiency and reduced emissions. While hydrogen fuel may be stored in a liquid state, the hydrogen fuel must be converted to a gaseous state before being combusted. For example, the hydrogen fuel must be heated sufficiently to be converted to the gaseous state and to enable effective combustion.

While a goal of fuel systems for gas turbine engines is to sufficiently heat the hydrogen fuel such that it is converted to a gaseous state at a temperature for effective combustion, it is also desirable to ensure that the hydrogen fuel's low temperature in the liquid state is utilized to cool components of the gas turbine engine. Once converted to the gaseous state, at least a portion of the gaseous hydrogen fuel may be utilized by fuel cells to generate electrical energy. Additionally, combustion using hydrogen fuel produces more water. Accordingly, it is desirable for fuel systems to effectively utilize excess water produced by combustion of the hydrogen fuel.

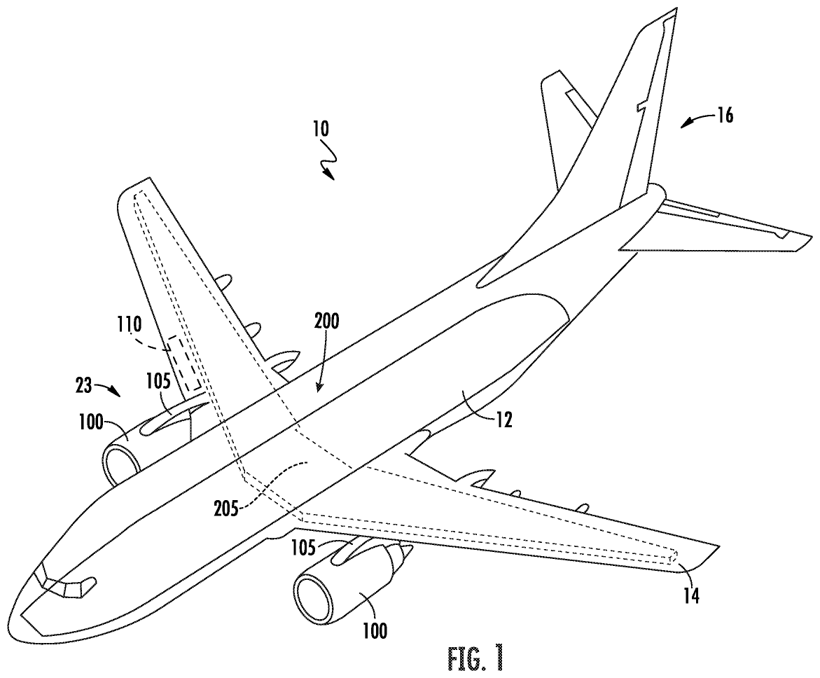

Referring now to the drawings, a perspective view of a vehicle of the present disclosure is provided. Specifically, for the exemplary embodiment of FIG. 1, the vehicle is configured as an aeronautical vehicle, or aircraft 10. The exemplary aircraft 10 has a vehicle body, and more specifically has a fuselage 12, wings 14 attached to the fuselage 12, and an empennage 16.

The exemplary aircraft 10 includes a fuel system 200 having a fuel tank 205. For the example depicted, the fuel system 200 uses a cryogenic fuel. More specifically the fuel is a hydrogen fuel that may be stored in a liquid phase at cryogenic temperatures. Accordingly, the fuel tank 205 stores a hydrogen fuel in a liquid phase. In the exemplary aircraft 10 shown in FIG. 1, at least a portion of the fuel tank 205 is located in a wing 14 of the aircraft 10. In some embodiments, however, the fuel tank 205 may be located at other locations in the fuselage 12 or the wing 14. It will be appreciated that the hydrogen fuel is stored in the fuel tank 205 at a relatively low temperature. For example, the hydrogen fuel may be stored in the fuel tank 205 at about −253 degrees Celsius or less at an atmospheric pressure, or at other temperatures and pressures to maintain the hydrogen fuel substantially in the liquid phase. The fuel tank 205 may be made from materials such as titanium, Inconel, aluminum, or composite materials.

The aircraft 10 further includes a propulsion system 23 operable with the vehicle body that produces a propulsive thrust required to propel the aircraft 10 in flight, during taxiing operations, etc. Although the propulsion system 23 is shown attached to the wing(s) 14 in FIG. 1, in other embodiments it may additionally or alternatively include one or more aspects coupled to other parts of the aircraft 10, such as, for example, the empennage 16, the fuselage 12, or both.

For the exemplary aspect depicted, the propulsion system 23 includes an engine, and more specifically includes a pair of engines. More specifically, still, each of the engines in the pair of engines is configured as a gas turbine engine 100 mounted to one of the respective wings 14 of the aircraft 10 in an under-wing configuration through a respective pylon 105. Each gas turbine engine 100 is capable of selectively generating a propulsive thrust for the aircraft 10. The amount of propulsive thrust may be controlled at least in part based on a volume (or, more specifically, a mass flowrate) of fuel provided to the gas turbine engines 100 via the fuel system 200.

Briefly, it will be appreciated that the aircraft 10 may include one or more compartments 110 in the wings 14 or elsewhere, through which at least a portion of a fuel delivery system of the fuel system 200 in fluid communication with the fuel tank 205 extends.

Notably, the embodiment depicted in FIG. 1 is by way of example only. In other exemplary embodiments, any other suitable aircraft 10 may be provided, and may include one or more of the gas turbine engines 100 mounted to the wings, mounted to the fuselage, integrated into the fuselage, mounted to or integrated into a stabilizer, etc.

FIG. 2 is a schematic cross-sectional view of the gas turbine engine 100 according to an exemplary embodiment of the present disclosure.

As shown in FIG. 2, the gas turbine engine 100 has an axial direction A (extending parallel to a longitudinal centerline axis 120) and a radial direction R that is normal to the axial direction A. In general, the gas turbine engine 100 includes a fan section 140 and a turbomachine 160 disposed downstream from the fan section 140.

The turbomachine 160 includes an outer casing 18 that is substantially tubular and defines an annular core inlet 20. As schematically shown in FIG. 2, the outer casing 18 encases, in serial flow relationship, a compressor section 21 including a booster or a low-pressure compressor (“LPC”) 22 followed downstream by a high-pressure compressor (“HPC”) 24, a combustion section 26, a turbine section 27, including a high-pressure turbine (“HPT”) 28, followed downstream by a low-pressure turbine (“LPT”) 30, and one or more core exhaust nozzles 32. A high-pressure (“HP”) shaft 34 or a spool drivingly connects the HPT 28 to the HPC 24 to rotate the HPT 28 and the HPC 24 in unison. The HPT 28 is drivingly coupled to the HP shaft 34 to rotate the HP shaft 34 when the HPT 28 rotates. A low-pressure (“LP”) shaft 36 drivingly connects the LPT 30 to the LPC 22 to rotate the LPT 30 and the LPC 22 in unison. The LPT 30 is drivingly coupled to the LP shaft 36 to rotate the LP shaft 36 when the LPT 30 rotates. The compressor section 21, the combustion section 26, the turbine section 27, and the one or more core exhaust nozzles 32 together define a working gas flow path 33.

For the embodiment depicted in FIG. 2, the fan section 140 includes a fan 38 (e.g., a variable pitch fan) having a plurality of fan blades 40 coupled to a disk 42 in a spaced apart manner. As depicted in FIG. 2, the fan blades 40 extend outwardly from the disk 42 generally along the radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are together rotatable about the longitudinal centerline axis 120 via a fan shaft 45 that is powered by the LP shaft 36 across a power gearbox, also referred to as a gearbox assembly 46. The gearbox assembly 46 is shown schematically in FIG. 2. The gearbox assembly 46 includes a plurality of gears for adjusting the rotational speed of the fan shaft 45 and, thus, the fan 38 relative to the LP shaft 36.

Referring still to the exemplary embodiment of FIG. 2, the disk 42 is covered by a rotatable fan hub 48 aerodynamically contoured to promote an airflow through the plurality of fan blades 40. In addition, the fan section 140 includes an annular fan casing or a nacelle 50 that circumferentially surrounds the fan 38 and/or at least a portion of the turbomachine 160. The nacelle 50 is supported relative to the turbomachine 160 by a plurality of circumferentially spaced outlet guide vanes 52. Moreover, a downstream section 54 of the nacelle 50 extends over an outer portion of the turbomachine 160 to define a bypass airflow passage 56 therebetween. The one or more core exhaust nozzles 32 may extend through the nacelle 50 and be formed therein. In this exemplary embodiment, the one or more core exhaust nozzles 32 include one or more discrete nozzles that are spaced circumferentially about the nacelle 50. Other arrangements of the core exhaust nozzles 32 may be used including, for example, a single core exhaust nozzle that is annular, or partially annular, about the nacelle 50.

During operation of the gas turbine engine 100, a volume of air 58 enters the gas turbine engine 100 through an inlet 60 of the nacelle 50 and/or the fan section 140. As the volume of air 58 passes across the fan blades 40, a first portion of air (bypass air 62) is directed or routed into the bypass airflow passage 56, and a second portion of air (core air 64) is directed or is routed into the upstream section of the working gas flow path 33, or, more specifically, into the annular core inlet 20. The ratio between the first portion of air (bypass air 62) and the second portion of air (core air 64) is known as a bypass ratio. In some embodiments, the bypass ratio is greater than 18:1. The pressure of the core air 64 is then increased by the LPC 22, generating compressed air 65, and the compressed air 65 is routed through the HPC 24 and further compressed before being directed into a combustion chamber of the combustion section 26, where the compressed air 65 is mixed with fuel and burned to generate combustion gases 66 (combustion products). One or more stages may be used in each of the LPC 22 and the HPC 24, with each subsequent stage further compressing the compressed air 65. The HPC 24 has a compression ratio greater than 20:1, preferably, in a range of 20:1 to 40:1. The compression ratio is a ratio of a pressure of a last stage of the HPC 24 to a pressure of a first stage of the HPC 24. The compression ratio may be greater than 20:1.

The combustion gases 66 are routed into the HPT 28 and expanded through the HPT 28 where a portion of thermal energy and/or kinetic energy from the combustion gases 66 is extracted via sequential stages of HPT stator vanes 68 that are coupled to the outer casing 18 and HPT rotor blades 70 that are coupled to the HP shaft 34, thus, causing the HP shaft 34 to rotate, which supports operation of the HPC 24. The combustion gases 66 are then routed into the LPT 30 and expanded through the LPT 30. Here, a second portion of thermal energy and/or the kinetic energy is extracted from the combustion gases 66 via sequential stages of LPT stator 72 that are coupled to the outer casing 18 and LPT rotor blades 74 that are coupled to the LP shaft 36, thus, causing the LP shaft 36 to rotate, which supports operation of the LPC 22 and rotation of the fan 38 via the gearbox assembly 46. One or more stages may be used in each of the HPT 28 and the LPT 30. The HPC 24 having a compression ratio in a range of 20:1 to 40:1 enables the HPT 28 to have a pressure expansion ratio in a range of 1.5:1 to 4:1 and the LPT 30 having a pressure expansion ratio in a range of 4.5:1 to 28:1.

The combustion gases 66 are subsequently routed through the one or more core exhaust nozzles 32 of the turbomachine 160 to provide propulsive thrust. Simultaneously with the flow of the core air 64 through the working gas flow path 33, the bypass air 62 is routed through the bypass airflow passage 56 before being exhausted from a fan bypass nozzle 76 of the gas turbine engine 100, also providing propulsive thrust. The HPT 28, the LPT 30, and the one or more core exhaust nozzles 32 at least partially define a hot gas path 78 for routing the combustion gases 66 through the turbomachine 160.

In at least one example embodiment, such as the exemplary embodiment shown, the gas turbine engine 100 includes the fuel system 200. The fuel system 200 is configured to provide a fuel flow to a combustor or combustion section of the combustion section 26 of the turbomachine 160. The fuel system 200 includes a fuel source, such as the fuel tank 205, for storing the fuel.

As noted above, the compressed air 65 (the core air 64) is mixed with the fuel in the combustion section 26 to generate a fuel and air mixture, and combusted, generating combustion gases 66 (combustion products). The fuel can include any type of fuel used for turbine engines, such as, for example, sustainable aviation fuels (SAF) including biofuels, JetA, or other hydrocarbon fuels. The fuel also may be a hydrogen-based fuel (H₂), and, while hydrogen-based fuel may include blends with hydrocarbon fuels, the fuel used herein is preferably unblended, and referred to herein as hydrogen fuel. In some embodiments, the hydrogen fuel may include substantially pure hydrogen molecules (i.e., diatomic hydrogen).

The gas turbine engine 100 depicted in FIG. 2 is by way of example only. In other exemplary embodiments, the gas turbine engine 100 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, and/or turboprop engines.

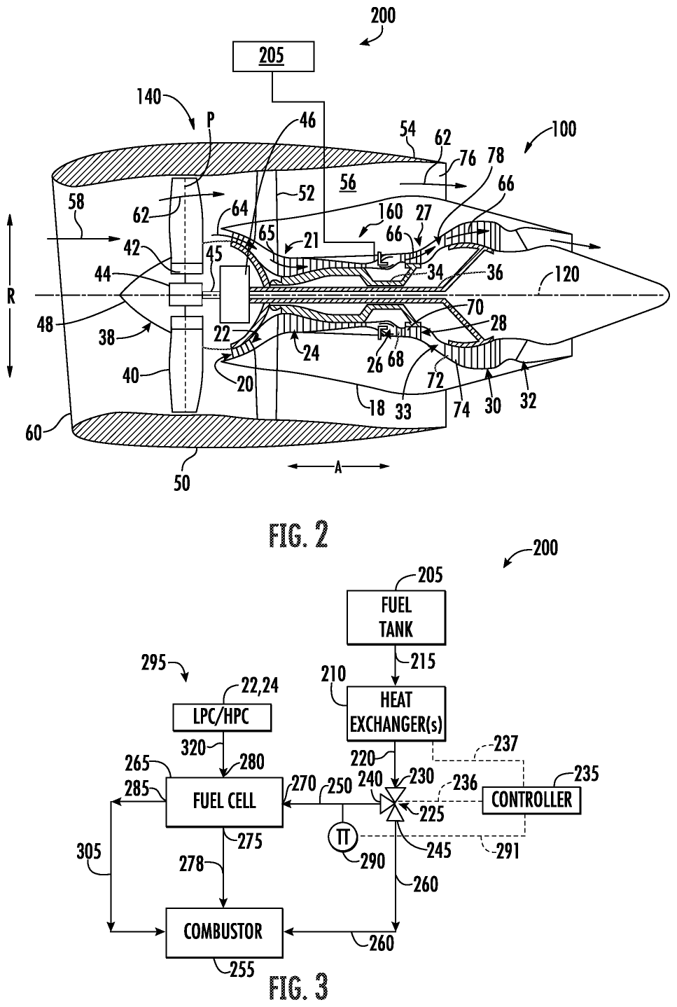

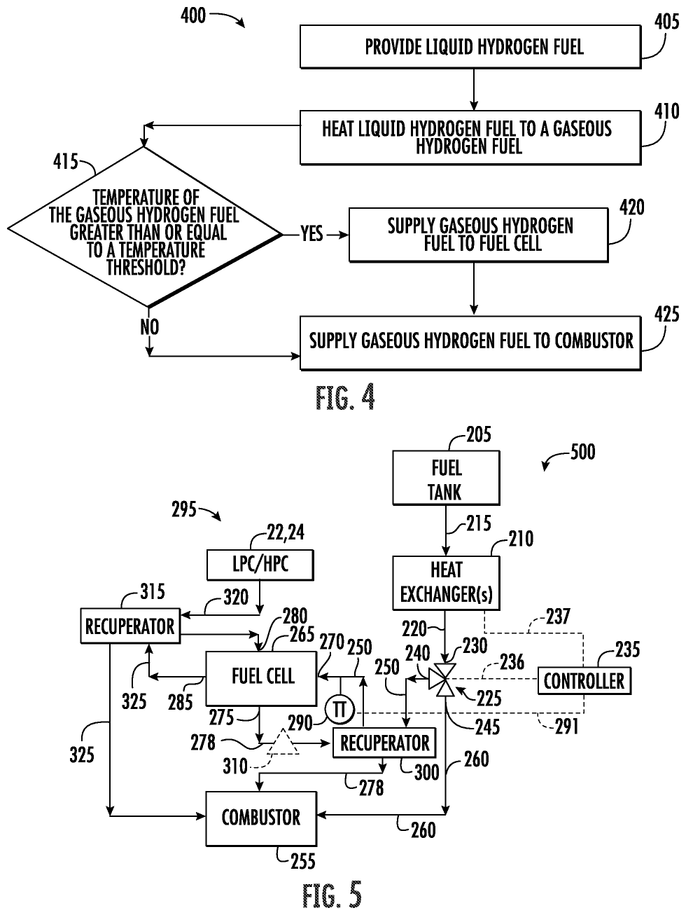

FIG. 3 is a schematic diagram of the fuel system 200 of the gas turbine engine of FIG. 2 according to an exemplary embodiment of the present disclosure.

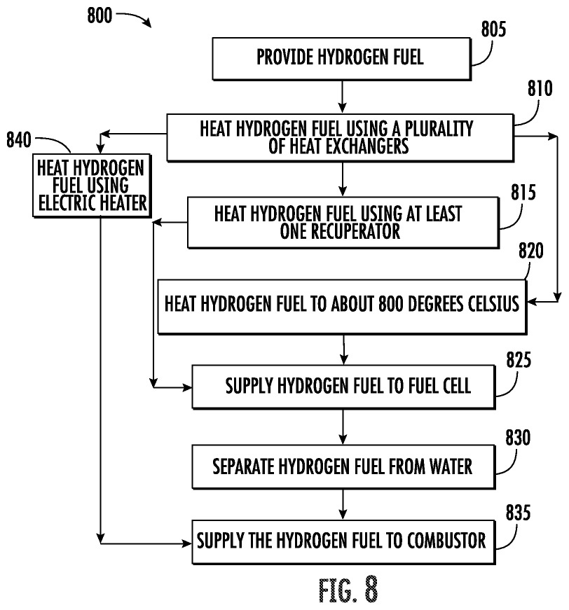

As shown in FIG. 3, the fuel system 200 includes a plurality of heat exchangers 210 in fluid communication with and downstream of the fuel tank 205. The plurality of heat exchangers 210 may include a fuel-air heat exchanger, a fuel-oil heat exchanger, a fuel-working fluid heat exchanger, or a combination thereof. The plurality of heat exchangers 210 are configured to receive the fuel, such as a liquid hydrogen fuel 215, from the fuel tank 205. The plurality of heat exchangers 210 may receive the liquid hydrogen fuel 215 via a pump (shown in FIG. 7). The liquid hydrogen fuel 215 may flow from the fuel tank 205 to the plurality of heat exchangers 210 via a fluid passage defined by various, pipes, tubes, conduits, valves, fluid couplings, or a combination thereof (not shown).

In at least one example embodiment, the plurality of heat exchangers 210 are configured to heat the liquid hydrogen fuel 215 received from the fuel tank 205. For example, the plurality of heat exchangers 210 may heat the liquid hydrogen fuel 215 to a desired temperature. The desired temperature may be a temperature at which the liquid hydrogen fuel 215 is converted to a gaseous phase. In at least one example embodiment, the plurality of heat exchangers 210 are configured to heat the liquid hydrogen fuel 215 from about −250° C. to about 550° C. at about 137 bar to convert the liquid hydrogen fuel 215 to a gaseous state suitable for combustion. Accordingly, the plurality of heat exchangers 210 may provide a gaseous hydrogen fuel 220.

As shown in FIG. 3, the fuel system 200 includes a valve 225 having fuel inlet, such as a valve inlet 230, in fluid communication with the plurality of heat exchangers 210. The valve 225 is configured to receive the gaseous hydrogen fuel 220 via the valve inlet 230. Actuation or manipulation of the valve 225 may be controlled by a controller 235 communicatively coupled to the valve 225. In at least one example embodiment, the controller 235 may be a full authority digital engine control

(“FADEC”) controller. However, in other example embodiments, other suitable controllers may be provided.

In at least one example embodiment, the controller 235 is also communicatively coupled to the plurality of heat exchangers 210. In such embodiments, the controller 235 is configured to send an electrical signal, such as a flow rate signal 237, to one or more of the plurality of heat exchangers 210 to control a flow rate of fluids through the plurality of heat exchangers 210. For example, the controller 235 may control the flow rate of hot fluids flowing through the plurality of heat exchangers 210. The hot fluids flowing through the plurality of heat exchangers 210 are configured to transfer heat to the liquid hydrogen fuel 215 also flowing through the plurality of heat exchangers 210.

The valve 225 may be a multi-way valve. For example, in the embodiment shown, the valve 225 may be a three-way valve. The valve 225 includes at least a first fuel outlet, such as a first valve outlet 240, and a second fuel outlet, such as a second valve outlet 245. The first valve outlet 240 may be in fluid communication with a first fluid pathway 250. The second valve outlet 245 may be in fluid communication with a combustor 255 via a second fluid pathway 260. The combustor 255 may be integrated with combustion section 26 of the turbomachine 160, as shown in FIG. 2, or may be independent thereof. For example, the combustor 255 may be part of a combustion system for an auxiliary power unit (not shown). One or more additional heat exchangers may also be disposed upstream of the auxiliary power unit for heating the fuel.

In at least one example embodiment, a fuel cell 265 is disposed downstream of the first valve outlet 240 and in fluid communication with the first fluid pathway 250. The fuel cell 265 may include a solid oxide fuel cell (“SOFC”). Additionally, the fuel cell 265 may be configured to generate electrical power for the gas turbine engine 100, the aircraft 10, or a combination thereof. The fuel cell 265 includes an anode inlet 270 fluidly coupled to and in fluid communication with the first fluid pathway 250 and an anode outlet 275 fluidly coupled to and in fluid communication with the combustor 255 via a third fluid pathway 278. The fuel cell 265 also include a cathode inlet 280 and a cathode outlet 285. An anode flow passage passes through the fuel cell 265 and is fluidly coupled to and in fluid communication with the anode inlet 270 and the anode outlet 275. A cathode flow passage passes through the fuel cell 265 and is fluidly coupled to and in fluid communication with the cathode inlet 280 and the cathode outlet 285. The cathode flow passage is fluidly isolated from the anode flow passage. Additionally, the cathode flow passage and the anode flow passage may be in thermal communication.

As mentioned above, the controller 235 is communicatively coupled to the valve 225 and is configured to send an electrical signal, such as a valve command signal 236, to the valve 225 to manipulate the valve 225 so as to control a flow of the gaseous hydrogen fuel 220 to one or both of the fuel cell 265, via the first fluid pathway 250 and the anode inlet 270, and the combustor 255, via the second fluid pathway 260. For example, the controller 235 may send the valve command signal 236 to adjust one or both of the first valve outlet 240 and the second valve outlet 245 of the valve 225 from a fully closed or zero flow position, to a fully open or full flow position, or to any open positions defined therebetween to meter or control a flow volume through the valve 225.

In at least one example embodiment, the controller 235 may send the valve command signal 236 to the valve 225 to close the first valve outlet 240 and at least partially open the second valve outlet 245 to allow the gaseous hydrogen fuel 220 to flow to the combustor 255, bypassing the fuel cell 265. For example, the fuel cell 265 may be bypassed to enable direct fuel combustion during a cold start-up process of the turbomachine 160.

The controller 235 may also send the valve command signal 236 to the valve 225 to close the first valve outlet 240 and at least partially open the second valve outlet 245 to allow the gaseous hydrogen fuel 220 to flow to the combustor 255, bypassing the fuel cell 265, if a temperature of the gaseous hydrogen fuel 220 is not greater than or equal to a threshold temperature for utilization by the fuel cell 265. For example, a temperature sensor 290 may be disposed in fluid communication with the first fluid pathway 250 between the fuel cell 265 and the valve 225. The temperature sensor 290 may also be communicatively coupled to the controller 235 and configured to measure and send an electrical signal, such as a temperature signal 291, to the controller 235 indicative of a fuel temperature of the gaseous hydrogen fuel 220 within the first fluid pathway 250. If the fuel temperature measured by the temperature sensor 290 is below the temperature threshold, the controller 235 may send the valve command signal 236 to the valve 225 to close the first valve outlet 240 and open the second valve outlet 245 to allow the gaseous hydrogen fuel 220 to flow to the combustor 255, bypassing the fuel cell 265. If the fuel temperature measured by the temperature sensor 290 is greater than or equal to the threshold temperature, the controller 235 may send the valve command signal 236 to the valve 225 to at least partially open the first valve outlet 240 to direct at least a portion of the gaseous hydrogen fuel to the fuel cell 265. In at least one example embodiment, the temperature threshold for the gaseous hydrogen fuel 220 is between about 500° C. and about 1000° C. For example, the temperature threshold for the gaseous hydrogen fuel 220 may be about 800° C.

In at least one example embodiment, the fuel cell 265 may be in fluid communication with a cathode air source 295 via a fourth fluid pathway 320. The cathode air source 295 may include one or both of the LPC 22 and the HPC 24 of the compressor section 21. The cathode air source 295 may be fluidly coupled to and in fluid communication with the cathode inlet 280 of the fuel cell 265. For example, the cathode air source 295 may supply air, such as bleed air from the LPC 22 and the HPC 24, to the fuel cell 265. Within the fuel cell 265, the gaseous hydrogen fuel 220 reacts as an anode with the bleed air provided by the cathode air source 295. The cathode air reacts as a cathode within the fuel cell 265. Excess air from the exothermic reaction within the fuel cell 265 may be routed from the cathode outlet 285 to the one or more other components or systems of the gas turbine engine 100 or the aircraft 10, such as but not limited to the combustor 255. In the example shown in FIG. 3, the cathode outlet 285 may be in fluid communication with the combustor 255 via a fifth fluid pathway 305. Accordingly, the excess air may be exhausted from the fuel cell 265 via the cathode outlet 285 and the fifth fluid pathway 305 to the combustor 255. Moreover, excess fuel within the fuel cell 265 may be routed from the anode outlet 275 to the combustor 255 via the third fluid pathway 278.

FIG. 4 is a flow chart of a method 400 of operating the fuel system 200 of FIG. 3 according to an exemplary embodiment of the present disclosure.

In at least one example embodiment, the method 400 includes providing a liquid hydrogen fuel at 405, heating the liquid hydrogen fuel to a gaseous hydrogen fuel at 410, determining if a temperature of the gaseous hydrogen fuel is greater than or equal to a temperature threshold at 415, supplying the gaseous hydrogen fuel to a fuel cell at 420, and supplying the gaseous hydrogen fuel to a combustor at 425.

In at least one example embodiment, providing the liquid hydrogen fuel at 405 includes providing the liquid hydrogen fuel 215 from the fuel tank 205 to the plurality of heat exchangers 210. For example, a pump (shown in FIG. 7) may generate a flow of the liquid hydrogen fuel 215 from the fuel tank 205 to the plurality of heat exchangers 210. Heating the liquid hydrogen fuel to a gaseous hydrogen fuel at 410 includes heating the liquid hydrogen fuel 215 to a desired temperature at which the liquid hydrogen fuel 215 is converted to the gaseous hydrogen fuel 220. For example, the plurality of heat exchangers 210 may heat the liquid hydrogen fuel 215 from about −250° C. to about 550° C. at about 137 bar to convert the liquid hydrogen fuel 215 to a gaseous state.

In at least one example embodiment, determining if a temperature of the gaseous hydrogen fuel is greater than or equal to a temperature threshold at 415 includes determining if the temperature of the gaseous hydrogen fuel 220 is greater than or equal to a temperature threshold for use by the fuel cell 265. For example, the temperature sensor 290 may measure the temperature of the gaseous hydrogen fuel 220 and provide the temperature to the controller 235 via the temperature signal 291. The controller 235 may then determine if the temperature of the gaseous hydrogen fuel 220 measured by the temperature sensor 290 is greater than or equal to the temperature threshold. In at least one example embodiment, the temperature threshold for the gaseous hydrogen fuel 220 is between about 500° C. and about 1000° C. For example, the temperature threshold for the gaseous hydrogen fuel 220 may be about 800° C., which is the temperature at which the fuel cell 265 may effectively utilize the gaseous hydrogen fuel 220.

If the temperature of the gaseous hydrogen fuel 220 is greater than or equal to the temperature threshold at 415, the gaseous hydrogen fuel 220 may be supplied to the fuel cell 265 at 420. For example, the controller 235 may send the valve command signal 236 to the valve 225 to open the first valve outlet 240 at least partially to direct at least a portion of the gaseous hydrogen fuel 220 to the fuel cell 265, as discussed above with respect to FIG. 3. If the temperature of the gaseous hydrogen fuel 220 is not greater than or equal to the temperature threshold, and thus is less than the temperature threshold, at 415, the gaseous hydrogen fuel 220 may be supplied to the combustor 255 at 425. For example, the controller 235 may send the valve command signal 236 to the valve 225 to close the first valve outlet 240 and open the second valve outlet 245 at least partially to allow the gaseous hydrogen fuel 220 to flow to the combustor 255, bypassing the fuel cell 265, as also discussed above with respect to FIG. 3.

FIG. 5 is a schematic diagram of a fuel system 500 of the gas turbine engine 100 of FIG. 2 according to an exemplary embodiment of the present disclosure. The exemplary fuel system 500 of FIG. 5 may be incorporated into or used in place of the fuel system 200 described above with respect to FIGS. 2-3, in some example embodiments. As shown in FIG. 5, the fuel system 500 includes the fuel tank 205, the plurality of heat exchangers 210, the valve 225, the controller 235, the combustor 255, the fuel cell 265, and the cathode air source 295, which may be similar or analogous to the fuel tank 205, the plurality of heat exchangers 210, the valve 225, the controller 235, the combustor 255, the fuel cell 265, and the cathode air source 295 discussed above with respect to FIG. 3.

In at least one example embodiment, the fuel system 500 includes an additional heat exchanger, such as a first recuperator 300, disposed in the first fluid pathway 250. The first recuperator 300 may be positioned downstream of the valve 225 and upstream of the fuel cell 265 such that the first recuperator 300 is in fluid communication with the valve 225 and the fuel cell 265. Additionally, the first recuperator 300 is in fluid communication with the combustor 255 via the third fluid pathway 278. For example, the first recuperator may be downstream of the anode outlet 275 of the fuel cell 265 and upstream of the combustor 255 along the third fluid pathway 278. The first recuperator 300 may include a first fuel passage in fluid communication with the first fluid pathway 250 and a second fluid passage in fluid communication with the third fluid pathway 278. The first fuel passage and the second fuel passage of the first recuperator 300 may be fluidly isolated. Moreover, the first fuel passage and the second fuel passage of the first recuperator 300 may be in thermal communication. For example, the first recuperator 300 is configured to heat the gaseous hydrogen fuel 220 received by the first fuel passage from the first fluid pathway 250 using heat from excess fuel received by the second fuel passage from the anode outlet 275 of the fuel cell 265 via the third fluid pathway 278.

In at least one example embodiment, a secondary valve 310 may optionally be disposed in the third fluid pathway 278. For example, the secondary valve 310 may be downstream of the anode outlet 275 of the fuel cell 265 and upstream of the first recuperator 300. The secondary valve 310 may be configured to control an amount of the excess fuel delivered to the second fuel passage of the first recuperator 300 via the third fluid pathway 278 from the fuel cell 265. For example, the secondary valve 310 may be communicatively coupled to the controller 235 for actuating or manipulating the secondary valve 310 to control or allow excess fuel from the anode outlet 275 of the fuel cell 265 to flow to the first recuperator 300.

In at least one example embodiment, the controller 235 may send an electrical signal to the secondary valve 310 to allow at least a portion of the excess fuel from the anode outlet 275 of the fuel cell 265 to enter the first recuperator 300 when a temperature of the gaseous hydrogen fuel 220 in the first fluid pathway 250 is less than the temperature threshold discussed above with respect to FIG. 3. In some additional example embodiments, such as during transient conditions, the controller 235 may send an electrical signal to the secondary valve 310 to allow almost all the excess fuel from the anode outlet 275 to bypass the first recuperator 300, which may prevent thermal runaway with the exothermic reaction within the fuel cell 265.

As shown in FIG. 5, the fuel system 500 may include still an additional heat exchanger, such as a second recuperator 315. The second recuperator 315 may be disposed in the fourth fluid pathway 320 in fluid communication with the cathode air source 295 and the cathode inlet 280 of the fuel cell 265. Additionally, the second recuperator 315 may be disposed in a fifth fluid pathway 325 in fluid communication with the cathode outlet 285 of the fuel cell 265 and the combustor 255. The second recuperator 315 includes a first fluid passage in fluid communication with the fourth fluid pathway 320 and a second fluid pathway in fluid communication with the fifth fluid pathway 325. The first fluid pathway and the second fluid pathway of the second recuperator 315 may be fluidly isolated. Moreover, the first fluid pathway and the second fluid pathway of the second recuperator 315 may be in thermal communication. For example, the excess air discharged from the cathode outlet 285 of the fuel cell 265 may flow through the fifth fluid pathway 325 to the second fluid pathway of the second recuperator 315 and may transfer waste heat to air flowing through the first fluid pathway of the second recuperator 315 from the cathode air source 295. In this manner, the air supplied from the cathode air source 295 to the cathode inlet 280 of the fuel cell 265 may be heated, which may increase the efficiency of the fuel cell 265.

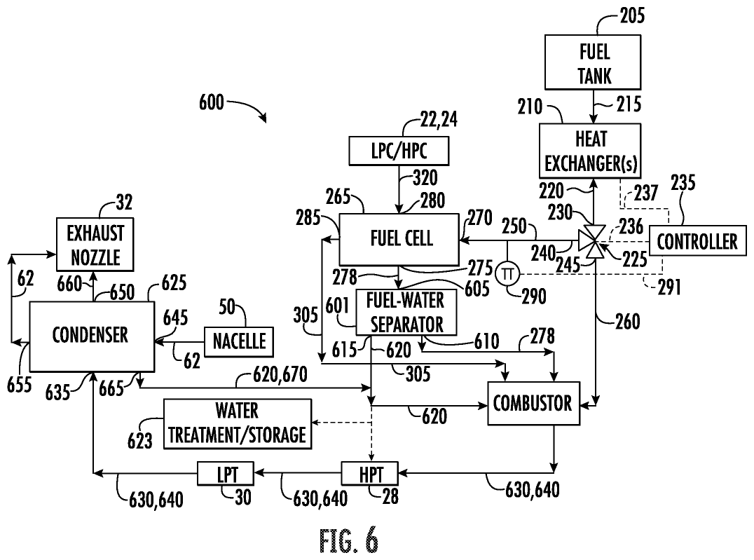

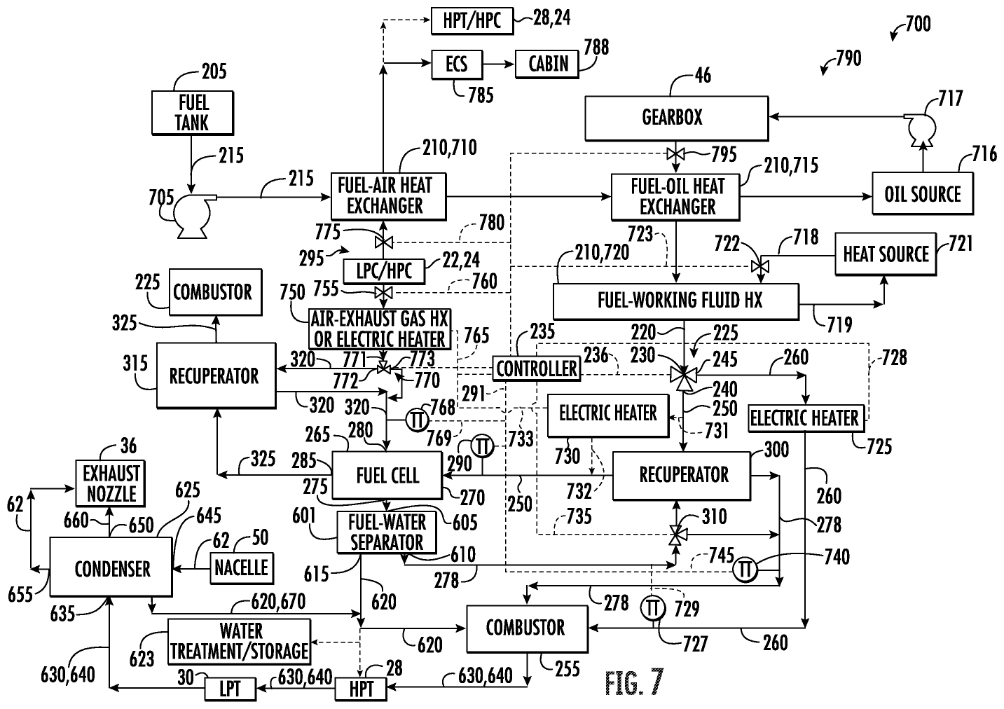

FIG. 6 is a schematic diagram of a fuel system 600 of the gas turbine engine 100 of FIG. 2 according to an exemplary embodiment of the present disclosure. The exemplary fuel system 600 of FIG. 6 may be incorporated into or used in place of the fuel system 200 described above with respect to FIGS. 2-3, in some example embodiments. As shown in FIG. 6, the fuel system 600 includes the fuel tank 205, the plurality of heat exchangers 210, the valve 225, the controller 235, the combustor 255, the fuel cell 265, and the cathode air source 295, which may be similar or analogous to the fuel tank 205, the plurality of heat exchangers 210, the valve 225, the controller 235, the combustor 255, the fuel cell 265, and the cathode air source 295 discussed above with respect to FIG. 3.

In at least one example embodiment, the fuel system 600 includes a fuel-water separator 601 disposed in the third fluid pathway 278 and in fluid communication with the fuel cell 265 and the combustor 255. The fuel cell 265 produces water as a byproduct of generating electrical power and the fuel-water separator 601 is configured to separate the water from excess fuel. The fuel-water separator 601 includes an inlet 605 in fluid communication with the anode outlet 275 of the fuel cell 265 via the third fluid pathway 278. The inlet 605 is configured to receive a fuel-water mixture from the anode outlet 275 of the fuel cell 265. The fuel-water separator 601 also includes a fuel outlet 610 and a water outlet 615. After separating the fuel, such as the gaseous hydrogen fuel 220, from the water, the fuel-water separator 601 discharges the gaseous hydrogen fuel 220 from the fuel outlet 610 to the combustor 255 via the third fluid pathway 278. Additionally, the fuel-water separator 601 discharges the water from the water outlet 615 to a sixth fluid pathway 620. For example, the water may be discharged from the water outlet 615 of the fuel-water separator 601 to the combustor 255 via the sixth fluid pathway 620 for nitrogen oxide reduction. In some example embodiments, the water may be discharged from the water outlet 615 of the fuel-water separator 601 to one or both of the HPT 28 and the LPT 30 of the turbine section 27 via the sixth fluid pathway 620 for turbine cooling. In some additional example embodiments, the water may be discharged from the water outlet 615 of the fuel-water separator 601 to water treatment and storage system 623 onboard the aircraft 10 via the sixth fluid pathway 620.

With reference to FIG. 6, the fuel system 600 includes an air-exhaust heat exchanger, such as a condenser 625. Combustion of hydrogen fuel produces more water than conventional gas turbine engines utilizing hydrocarbon fuel. For example, combustion of hydrogen fuel may produce about seven times more water than combustion of hydrogen fuels. Accordingly, the condenser 625 is configured to recover and effectively utilize water produced from the combustion process. More specifically, the condenser 625 is configured to reduce water content in exhaust gas, which may minimize contrail formation.

In at least one example embodiment, the condenser 625 is in fluid communication with the combustor 255 via a seventh fluid pathway 630. The condenser 625 includes an exhaust inlet 635 configured to receive hot exhaust gas 640 from the combustor 255. One or both of the HPT 28 and the LPT 30 of the turbine section 27 may be in fluid communication with the seventh fluid pathway 630 such that the hot exhaust gas 640 also passes through one or both of the HPT 28 and the LPT 30 before entering the condenser 625 via the exhaust inlet 635. Additionally, the condenser 625 is at least partially in fluid communication with the bypass airflow passage 56 defined by the nacelle 50. For example, the condenser 625 is configured to receive at least a portion of the bypass air 62 via a bypass air inlet 645.

The condenser 625 includes an exhaust passage in fluid communication with the exhaust inlet 635 and an exhaust outlet 650 of the condenser 625. The condenser 625 also includes an airflow passage in fluid communication with the bypass air inlet 645 and a bypass air outlet 655. The exhaust passage and the airflow passage of the condenser 625 may be fluidly isolated. Moreover, the exhaust passage and the airflow passage of the condenser 625 may be in thermal communication. For example, the exhaust passage of the condenser 625 receives the hot exhaust gas 640 via the exhaust inlet 635 and the airflow passage of the condenser 625 receives the bypass air 62 via the bypass air inlet 645. Within the condenser 625, heat from the hot exhaust gas 640 within the exhaust passage is transferred to the bypass air 62 within the airflow passage. Accordingly, cooled exhaust gas 660 is discharged from the exhaust outlet 650 of the condenser 625 and the bypass air 62, which has been heated by the hot exhaust gas 540, is discharged from the bypass air outlet 655 of the condenser 625. The exhaust outlet 650 and the bypass air outlet 655 may be in fluid communication with the one or more core exhaust nozzles 32 such that the bypass air 62 and the cooled exhaust gas 660 may be discharged via the one or more core exhaust nozzles 32.

Still referring to FIG. 6, the condenser 625 may also include a water outlet 665 in fluid communication with the sixth fluid pathway 620. In such embodiments, condensate water 670 may be discharged from the water outlet 665 to the combustor 255, the HPT 28, the water treatment and storage system 623, or a combination thereof via the sixth fluid pathway 620.

FIG. 7 is a schematic diagram of a fuel system 700 of the gas turbine engine 100 of FIG. 2 according to an exemplary embodiment of the present disclosure. The exemplary fuel system 700 of FIG. 7 may be incorporated into or used in place of the fuel system 200 described above with respect to FIGS. 2-3, in some example embodiments. As shown in FIG. 7, the fuel system 700 includes the fuel tank 205, the plurality of heat exchangers 210, the valve 225, the controller 235, the combustor 255, the fuel cell 265, and the cathode air source 295, which may be similar or analogous to the fuel tank 205, the plurality of heat exchangers 210, the valve 225, the controller 235, the combustor 255, the fuel cell 265, and the cathode air source 295 discussed above with respect to FIG. 3. Moreover, the fuel system 700 may include a combination of the fuel systems 200, 500, and 600.

In at least one example embodiment, the fuel system includes a pump 705 in fluid communication with the fuel tank 205. The pump 705 is configured to generate a flow of the liquid hydrogen fuel 215 from the fuel tank 205. For example, the pump 705 generates a flow of the liquid hydrogen fuel 215 to the plurality of heat exchangers 210.

As shown in FIG. 7, the plurality of heat exchanger 210 may include a fuel-air heat exchanger 710, a fuel-oil heat exchanger 715, and a fuel-working fluid heat exchanger 720 in fluid communication with the fuel tank 205. As discussed above with respect to the plurality of heat exchangers 210 in FIG. 3, the fuel-air heat exchanger 710, the fuel-oil heat exchanger 715, and the fuel-working fluid heat exchanger 720 are configured to heat the liquid hydrogen fuel 215 to a gaseous state in which the liquid hydrogen fuel 215 received from the fuel tank 205 is converted to the gaseous hydrogen fuel 220.

The valve 225 is in fluid communication with and downstream of the fuel-air heat exchanger 710, the fuel-oil heat exchanger 715, and the fuel-working fluid heat exchanger 720. The valve 225 is configured to selectively control the flow of the gaseous hydrogen fuel 220 through one or both of the first valve outlet 240 and the second valve outlet 245. For example, the valve 225 may be actuated or manipulated by the controller 235 as discussed above with respect to FIG. 3.

As shown in FIG. 7, the fuel-working fluid heat exchanger 720 may be in fluid communication with a heat source 721. The heat source 721 may be configured to supply a hot working fluid 718 to the fuel-working fluid heat exchanger 720. The fuel flowing through the fuel-working fluid heat exchanger 720, such as the liquid hydrogen fuel 215 or the gaseous hydrogen fuel 220, may absorb heat from the hot working fluid 718. Accordingly, cooled working fluid 719 is discharged from the fuel-working fluid heat exchanger 720 and returned to the heat source 721. In at least one example embodiment, the heat source 721 includes a fuel cell, such as a solid oxide fuel cell.

Additionally, the fuel system 700 may include a working fluid valve 722 communicatively coupled to the controller 235. The controller 235 may be configured to send a working fluid control signal 723 to selectively control a flow of the hot working fluid 718 from the heat source 721 to the fuel-working fluid heat exchanger 720.

In at least one example embodiment, a first electric heater 725 is disposed in fluid communication with the second fluid pathway 260 such that the first electric heater 725 is downstream of the second valve outlet 245 and upstream of the combustor 255. The first electric heater 725 may be configured to heat the gaseous hydrogen fuel 220 within the second fluid pathway 260 before combustion by the combustor 255. For example, when the fuel cell 265 is bypassed, such as during a cold start-up process, the first electric heater 725 supplies heat to the gaseous hydrogen fuel 220.

A second temperature sensor 727 may also be disposed in fluid communication with the second fluid pathway 260 upstream of the combustor 255 for measuring a temperature of the gaseous hydrogen fuel 220 in the second fluid pathway 260. The first electric heater 725 and the second temperature sensor 727 may be communicatively coupled to the controller 235. The controller 235 may be configured to receive a second temperature signal 729 from the second temperature sensor 727 and send a first heater signal 728 to activate and deactivate the first electric heater 725 based on the second temperature signal 729. For example, the controller 235 may activate the first electric heater 725 via the first heater signal 728 if the temperature measured by the second temperature sensor 727 is less than a temperature threshold for combustion by the combustor 255.

In additional example embodiments, a second electric heater 730 may be disposed in fluid communication with the first fluid pathway 250. The second electric heater 730 may be upstream of the first recuperator 300, as indicated by arrow 731, or downstream of the first recuperator 300, as indicated by arrow 732. The second electric heater 730 may be configured to heat the gaseous hydrogen fuel 220 before the gaseous hydrogen fuel 220 enters the anode inlet 270 of the fuel cell 265. For example, the second electric heater 730 may be configured to heat the gaseous hydrogen fuel 220 if the temperature of the gaseous hydrogen fuel is not greater than or equal to the temperature threshold discussed above with respect to FIG. 3. Moreover, the second electric heater 730 may be communicatively coupled to the controller 235. The controller 235 may be configured to send a second heater signal 733 to activate and deactivate the second electric heater 730.

In other example embodiments, the second electric heater 730 may be a fuel-exhaust heat exchanger configured to transfer heat to the gaseous hydrogen fuel 220 flowing through the first fluid pathway 250.

In at least one example embodiment, as shown in FIG. 7, the secondary valve 310 may be in fluid communication with and downstream of the fuel-water separator 601 and in fluid communication with and upstream of the first recuperator 300. The secondary valve 310 is also upstream of the combustor 255. In such embodiments, the secondary valve 310 may be a multi-way valve, such as a three-way valve. Additionally, the secondary valve 310 is communicatively coupled to the controller 235. The controller 235 may send an electrical signal, such as secondary valve signal 735, to control or allow the gaseous hydrogen fuel 220 to flow from the fuel cell 265 and the fuel-water separator 601 to one or both of the first recuperator 300 and the combustor 255.

In some example embodiments, a third temperature sensor may be disposed in fluid communication with the third fluid pathway 278. For example, as shown in FIG. 7, the third temperature sensor 740 may be disposed downstream of the fuel-water separator 601 and the first recuperator 300 and upstream of the combustor 255. The third temperature sensor 740 may be communicatively coupled to the controller 235 via a third temperature signal 745. The controller 235 may control the secondary valve 310 based on the temperature received from the third temperature sensor 740 via the third temperature signal 745. For example, in some example embodiments, the third temperature sensor 740 measures a temperature of the excess hydrogen fuel discharged from the first recuperator 300 to the third fluid pathway 278 and sends an electrical signal to the controller 235 to open or close the secondary valve 310 based on the temperature measured by the third temperature sensor 740. Accordingly, if the secondary valve 310 is opened, excess fuel discharged from the anode outlet 275 of the fuel cell 265 may mix with the excess fuel discharged from the first recuperator 300 within the third fluid pathway 278 to optimize a temperature of the excess fuel provided to the combustor 255.

As shown in FIG. 7, the fuel system 700 includes an additional heat exchanger 750 disposed in the fourth fluid pathway 320. The additional heat exchanger 750 may include an air-exhaust heat exchanger. For example, the additional heat exchanger 750 is in fluid communication with the cathode air source 295 such that the additional heat exchanger receives an airflow, such as bleed air, from the cathode air source 295. The additional heat exchanger 750 may be configured to heat the airflow from the cathode air source 295 upstream of one or both of the second recuperator 315 and the fuel cell 265.

A third valve 755 may be disposed in fluid communication between the cathode air source 295 and the additional heat exchanger 750. The third valve 755 is configured to control a flow rate of the airflow from the cathode air source 295 to the additional heat exchanger 750. In at least one example embodiment, the third valve 755 is communicatively coupled to the controller 235. The controller 235 may be configured to send a third valve signal 760 to control the third valve 755. For example, the third valve signal 760 from the controller 235 may actuate the third valve 755 to an at least partially open position to allow the airflow to flow from the cathode air source 295 to the additional heat exchanger 750 or actuate the third valve 755 to a closed position in which the airflow from the cathode air source 295 is prevented from flowing to the additional heat exchanger 750.

In other example embodiments, the additional heat exchanger 750 includes an electric heater. In such embodiments, the electric heater may be communicatively coupled to the controller 235. For example, the controller 235 may send a heater signal 765 to activate and deactivate the electric heater. The electric heater may be configured to heat the airflow from the cathode air source 295 upstream of one or both of the second recuperator 315 and the fuel cell 265.

Still referring to FIG. 7, a fourth temperature sensor 768 may be disposed in the fourth fluid pathway 320. In at least one example embodiment, a threshold airflow temperature for the airflow supplied to the fuel cell 265 is between about 400° C. to about 850° C. to be effectively utilized by the fuel cell 265. The fourth temperature sensor 768 is configured to measure a temperature of the airflow upstream of the cathode inlet 280 of the fuel cell 265 and the controller 235 may be configured to determine if the temperature of the airflow measured by the fourth temperature sensor 768 is within the threshold airflow temperature. For example, the fourth temperature sensor 768 measures the temperature of the airflow upstream of the cathode inlet 280 and sends a fourth temperature signal 769 to the controller 235. Based on the electrical signal sent to the controller 235 from the fourth temperature sensor 768, the controller 235 may open or close the third valve 755 to control the flowrate of the airflow into the cathode inlet 280 of the fuel cell 265, send an electrical signal to activate the additional heat exchanger 750 to heat the airflow upstream of the cathode inlet 280 of the fuel cell 265, open or close a fourth valve 770 to control an amount of the airflow sent to the second recuperator 315, or a combination thereof.

In at least one example embodiment, the fourth valve 770 is disposed downstream of the additional heat exchanger 750 and upstream of both the fuel cell 265 and the second recuperator 315. The fourth valve 770 may be a multi-way valve, such as a three-way valve. The airflow from the additional heat exchanger 750 enters the fourth valve 770 via a valve inlet 771. The airflow may exit the fourth valve via a first valve outlet 772 in fluid communication with the second recuperator 315. Accordingly, the airflow from the cathode air source 295, the third valve 755, the additional heat exchanger 750 (or electric heater), and the first valve outlet 772 of the fourth valve 770 may flow into the second recuperator 315 and be utilized by the second recuperator 315 as discussed above with respect to FIG. 5. Additionally, or alternatively, the airflow may exit the fourth valve 770 via a second valve outlet 773 in order to bypass the second recuperator 315, such as in a cold start-up process. The second valve outlet 773 is in fluid communication with the cathode inlet 280 of the fuel cell 265. Moreover, the airflow may exit the fourth valve 770 via a second valve outlet 773 to bypass the second recuperator 315 in transient conditions to supply cooler air to the fuel cell 265, which may avoid thermal runaway from the exothermic reaction in the fuel cell 265.

In at least one example embodiment, the fuel system 700 is in fluid communication with one or both of the compressor section 21 and the turbine section 27 of the gas turbine engine 100. For example, airflow from the cathode air source 295 may be used to cool one or both of the HPT 28 and the HPC 24. Airflow from the cathode air source 295 may flow to one of the plurality of heat exchangers 210, such as the fuel-air heat exchanger 710, to heat the liquid hydrogen fuel 215 flowing through the fuel-air heat exchanger 710. The liquid hydrogen fuel 215 supplied to the fuel-air heat exchanger 710 absorbs heat from the airflow from the cathode air source. Accordingly, a cooled airflow 776 is discharged from the fuel-air heat exchanger 710 to one or both of the HPT 28 and the HPC 24 for cooling. Moreover, in some example embodiments, the fuel-air heat exchanger 710 may be in fluid communication with an environmental control system (“ECS”) 785 of the aircraft 10. Accordingly, the ECS 785 may generally be configured to receive at least a portion of the cooled airflow 776 from the fuel-air heat exchanger 710. The ECS 785 is further configured to condition the cooled airflow 776 and provide such airflow to a cabin 788 of the aircraft 10 to assist with pressurizing the cabin 788 and providing thermal control of the cabin 788, and optionally to provide cooling for accessory systems, such as avionics.

As shown in FIG. 7, the fuel system 700 may include a fifth valve 775 for controlling the airflow from the cathode air source 295 to the fuel-air heat exchanger 710. The fifth valve 775 may be communicatively coupled to the controller 235. The controller 235 may be configured to send a fifth valve signal 780 to control the fifth valve 775. For example, the fifth valve signal 780 from the controller 235 may actuate the fifth valve 775 to an at least a partially open position to allow airflow from the cathode air source 295 to flow to the fuel-air heat exchanger 710.

Still referring to FIG. 7, the fuel-oil heat exchanger 715 may be in fluid communication with an oil system 790. The oil system 790 may include an oil source 716, such as an oil tank, and an oil pump 717 configured to circulate the oil. For example, the oil pump 717 may generate a flow of oil from the oil source 716 to the fuel-oil heat exchanger 715. The oil system 790 may also include the gearbox assembly 46 downstream of the oil source 716 and upstream of the fuel-oil heat exchanger 715.

The oil system 790 may also include an oil valve 795 configured to selectively control a flow of the oil from the oil source 716 to the fuel-oil heat exchanger 715. As shown in FIG. 7, the oil valve 795 may be downstream of the oil source 716 and the gearbox assembly 46 and upstream of the fuel-oil heat exchanger 715. Additionally, the oil valve 795 may be communicatively coupled to the controller 235. The controller 235 may be configured to send an oil control signal 798 to control or actuate the oil valve 795. For example, the controller 235 may send the oil control signal 798 to the oil valve 795 for at least partially opening the oil valve 795 to allow at least a portion of the oil to flow to the fuel-oil heat exchanger 715 or close the oil valve 795 to prevent the flow of oil to the fuel-oil heat exchanger 715.

FIG. 8 is a flow chart of a method 800 of operating the fuel system 700 of FIG. 7 according to an exemplary embodiment of the present disclosure.

In at least one example embodiment, the method 800 includes providing a hydrogen fuel at 805, heating the hydrogen fuel using a plurality of heat exchangers at 810, heating the hydrogen fuel using at least one recuperator at 815, heating the hydrogen fuel to about 800° C. at 820, supplying the hydrogen fuel to a fuel cell at 825, separating the hydrogen fuel from water at 830, and supplying the separated hydrogen fuel to a combustor at 835.

Providing a hydrogen fuel at 805 includes providing the liquid hydrogen fuel 215 from the fuel tank 205 to the plurality of heat exchangers 210, as discussed above with respect to FIG. 7. Heating the hydrogen fuel using the plurality of heat exchangers at 710 includes heating the liquid hydrogen fuel 215 using the plurality of heat exchangers 210. For example, the plurality of heat exchangers 210 include the fuel-air heat exchanger 710, the fuel-oil heat exchanger 715, and the fuel-working fluid heat exchanger 720, as shown in FIG. 7. The plurality of heat exchangers 210 are configured to heat the liquid hydrogen fuel 215 to the gaseous hydrogen fuel 220.

During normal operation, the method 800 proceeds from step 810 to step 815. Heating the hydrogen fuel using at least one recuperator at 815 includes further heating the hydrogen fuel using the first recuperator 300, as discussed above with respect to FIG. 5. For example, the liquid hydrogen fuel 215 is heated to the gaseous hydrogen fuel 220, if not already done so by the plurality of heat exchangers 210, or the gaseous hydrogen fuel 220 is further heated at 815. Moreover, the gaseous hydrogen fuel 220 may be heated to about 800° C. by the first recuperator 300 in order for the gaseous hydrogen fuel 220 to be effectively utilized by the fuel cell 265.

Alternatively, during a cold start-up process, the method 800 may proceed from step 810 to 820. For example, the gaseous hydrogen fuel 220 may be supplied from the plurality of heat exchangers 210 to the second electric heater 730 via the first valve outlet 240 of the valve 225 and the first fluid pathway 250, as discussed above with respect to FIG. 7. The second electric heater 730 is configured to heat the gaseous hydrogen fuel 220 to a temperature between about 500° C. and about 1000° C., which is the temperature threshold for effective use of the gaseous hydrogen fuel by the fuel cell 265. For example, the second electric heater 730 may heat the gaseous hydrogen fuel 220 to about 800° C. at 820.

In other example embodiments, the gaseous hydrogen fuel 220 may be heated to about 800° C. at 820 using a fuel-exhaust heat exchanger in place of the second electric heater 730.

As shown in FIG. 8, the method 800 proceeds from step 820 to step 825 during the cold start-up process and proceeds from step 815 to step 825 during normal operation. Supplying hydrogen fuel to a fuel cell at 825 includes supplying the gaseous hydrogen fuel 220 to the fuel cell 265. The fuel cell 265 is configured to utilize the gaseous hydrogen fuel 220 to generate electrical power.

The fuel cell 265 produces water as a byproduct of producing electrical power. Accordingly, separating the hydrogen fuel from water at 830 includes separating an excess of the gaseous hydrogen fuel 220 from the water. For example, a fuel-water mixture is supplied to the fuel-water separator 601 from the fuel cell 265. The fuel-water separator 601 is configured to separate the gaseous hydrogen fuel 220 from the water, discharge the water from the water outlet 615 to the sixth fluid pathway 620, and discharge the gaseous hydrogen fuel 220 from the fuel outlet 610 to third fluid pathway 278, as discussed above with respect to FIG. 6.

Supplying the hydrogen fuel to a combustor at 835 includes supplying the gaseous hydrogen fuel from the fuel outlet 610 of the fuel-water separator 601 to the combustor 255 via the third fluid pathway 278. The gaseous hydrogen fuel 220 may be combusted by the combustor 255 to produce the combustion gases 66, as discussed above with respect to FIG. 2.

In at least one example embodiment, the method 800 may proceed from step 810 to step 840 to directly utilize the hydrogen fuel for combustion. After the hydrogen fuel is heated by the plurality of heat exchangers 210 at 810, the hydrogen fuel may be further heated by an electric heater at 840. For example, the gaseous hydrogen fuel 220 may be supplied from the plurality of heat exchangers 210 to the first electric heater 725 via the second valve outlet 245 of the valve 225 and the second fluid pathway 260. As discussed above with respect to FIG. 7, the first electric heater 725 may be configured to heat the gaseous hydrogen fuel 220 within the second fluid pathway 260 before combustion by the combustor 255. Accordingly, the method 800 may proceed from heating the gaseous hydrogen fuel 220 using the first electric heater 725 at 840 to supplying the hydrogen fuel to the combustor at 835.

Further aspects are provided by the subject matter of the following clauses:

A fuel system for a gas turbine engine including a compressor section, a combustion section, and a turbine section, the fuel system comprising: a fuel tank for storing a fuel; a plurality of heat exchangers downstream of the fuel tank; a valve downstream of the plurality of heat exchangers, the valve including a fuel inlet in fluid communication with the plurality of heat exchangers, a first fuel outlet in fluid communication with a first fluid pathway, and a second fuel outlet in fluid communication with a second fluid pathway; a fuel cell including an anode inlet and an anode outlet, the anode inlet in fluid communication with the first fluid pathway; a combustion chamber of the combustion section in fluid communication with the second fluid pathway and the anode outlet of the fuel cell; and a controller communicatively coupled to the valve and configured to generate a valve command signal for the valve for selectively controlling an amount of the fuel delivered to the first fluid pathway, the second fluid pathway, or both the first fluid pathway and the second fluid pathway based on a temperature of the fuel.

The fuel system of any preceding clause, wherein the controller is communicatively coupled to the plurality of heat exchangers and configured to control a flowrate of fluid through the plurality of heat exchangers.

The fuel system of any preceding clause, further comprising at least one temperature sensor disposed in the first fluid pathway and communicatively coupled to the controller, the at least one temperature sensor configured to measure the temperature of the fuel.

The fuel system of any preceding clause, wherein the controller is configured to generate the valve command signal based on the temperature of the fuel measured by the at least one temperature sensor.

The fuel system of any preceding clause, wherein the valve command signal comprises: opening the first fuel outlet of the valve and directing at least a portion of the fuel to the fuel cell in response to the temperature of the fuel being greater than or equal to a temperature threshold; and opening the second fuel outlet of the valve and directing at least a portion of the fuel to the combustion chamber in response to the temperature of the fuel being less than the temperature threshold.

The fuel system of any preceding clause, wherein the temperature threshold is greater than or equal to 500° C. and less than or equal to 1000° C.

The fuel system of any preceding clause, further comprising: a third fluid pathway between the anode outlet of the fuel cell and the combustion chamber; and a first recuperator including a first fuel passage in fluid communication with the first fluid pathway and a second fuel passage in fluid communication with the third fluid pathway; wherein the first recuperator is configured to heat the fuel in the first fuel passage using excess fuel received by the second fuel passage from the anode outlet.

The fuel system of any preceding clause, further comprising: a secondary valve disposed in the third fluid pathway between the anode outlet of the fuel cell and the second fuel passage of the first recuperator; wherein the secondary valve is configured to control an amount of the excess fuel delivered to the second fuel passage of the first recuperator from the fuel cell.

The fuel system of any preceding clause, wherein the fuel cell comprises: a cathode inlet in fluid communication with the compressor section via a fourth fluid pathway; and a cathode outlet in fluid communication with the combustion chamber via a fifth fluid pathway; wherein the fuel cell is configured to receive air from the compressor section via the cathode inlet; and wherein the combustion chamber is configured to receive excess air from the cathode outlet.

The fuel system of any preceding clause, further comprising at least one temperature sensor disposed in the fourth fluid pathway and communicatively coupled to the controller, the at least one temperature sensor configured to measure a temperature of air received from the compressor section.

The fuel system of any preceding clause, further comprising at least one valve disposed in the fourth fluid pathway, the at least one valve downstream of the compressor section and upstream of the fuel cell, wherein the at least one valve is configured to control an amount of the air delivered to the fuel cell.

The fuel system of any preceding clause, wherein the controller is configured to generate a valve command signal based on the temperature of the air measured by the at least one temperature sensor disposed in the fourth fluid pathway.

The fuel system of any preceding clause, further comprising: a second recuperator including a first fluid passage in fluid communication with the fourth fluid pathway and a second fluid passage in fluid communication with the fifth fluid pathway; wherein the first fluid passage of the second recuperator is in fluid communication with the compressor section and the cathode inlet of the fuel cell; wherein the second fluid passage of the second recuperator is in fluid communication with the cathode outlet and the combustion chamber; and wherein the second recuperator is configured to heat the air in the first fluid passage received from the compressor section using heat from the excess air received by the second fluid passage from the cathode outlet.

The fuel system of any preceding clause, further comprising: at least one electric heater upstream of the fuel cell and the combustion chamber; wherein the electric heater is configured to heat the fuel supplied to the fuel cell, the combustion chamber, or both the fuel cell and the combustion chamber.

The fuel system of any preceding clause, wherein the at least one electric heater is disposed in the second fluid pathway for heating the fuel supplied to the combustion chamber.

The fuel system of any preceding clause, wherein the at least one electric heater is disposed in the first fluid pathway for heating the fuel supplied to the fuel cell during a cold start-up process of the gas turbine engine.

The fuel system of any preceding clause, further comprising: an exhaust-gas heat exchanger downstream of the at least one electric heater; wherein the exhaust-gas heat exchanger is configured to heat the fuel when the gas turbine engine is no longer in the cold start-up process.

The fuel system of any preceding clause, wherein the controller is configured to control a flow rate of exhaust gas through the exhaust-gas heat exchanger.

The fuel system of any preceding clause, wherein: the controller is communicatively coupled to the at least one electric heater; and the controller is configured to generate a heater signal for regulating power delivered to the at least one electric heater.

The fuel system of any preceding clause, further comprising a condenser in fluid communication with the combustion chamber and an exhaust nozzle of the gas turbine engine.

The fuel system of any preceding clause, wherein the condenser is configured to reduce water content in exhaust gas received from the combustion chamber and reduce contrail formation.

The fuel system of any preceding clause, wherein: the condenser includes a liquid outlet fluidly coupled to the combustion chamber for reducing nitrogen oxides; the liquid outlet of condenser is fluid coupled to the turbine section for turbine cooling; and the liquid outlet of the condenser is fluidly coupled to a water treatment and storage system of the gas turbine engine.

The fuel system of any preceding clause, wherein the condenser comprises: an air inlet fluidly coupled to a nacelle of the gas turbine engine; and at least one air outlet fluidly coupled to the exhaust nozzle.

The fuel system of any preceding clause, further comprising: a fuel-water separator in fluid communication with the anode outlet of the fuel cell and the combustion chamber; wherein the fuel-water separator is configured to separate water from excess fuel discharged from the anode outlet the fuel cell.

The fuel system of any preceding clause, wherein: the excess fuel is delivered to the combustion chamber; and the water is delivered to the turbine section, a water treatment and storage system of the gas turbine engine, or a combination thereof.

The fuel system of any preceding clause, further comprising: an auxiliary power unit fluidly coupled to the combustion chamber; and one or more additional heat exchangers upstream of the auxiliary power unit for heating the fuel.

The fuel system of any preceding clause, wherein the plurality of heat exchangers comprise one or more of a fuel-air heat exchanger, a fuel-oil heat exchanger, a fuel-working fluid heat exchanger, or a combination thereof.

The fuel system of any preceding clause, wherein the fuel cell comprises a solid oxide fuel cell.

The fuel system of any preceding clause, wherein: the fuel stored in the fuel tank comprises a hydrogen fuel in a liquid phase; and the plurality of heat exchangers are configured to heat the hydrogen fuel to a gaseous phase.

The fuel system of any preceding clause, wherein the valve comprises a three-way valve.

A gas turbine engine, comprising: a fan; a turbomachine operably coupled to the fan for driving the fan, the turbomachine comprising a compressor section, a combustion section, and a turbine section in serial flow order and together defining a working gas flow path; and the fuel system of any preceding clause.

A method of operating a fuel system for a gas turbine engine, comprising: providing a liquid hydrogen fuel from a fuel tank to a plurality of heat exchangers; heating the liquid hydrogen fuel to a gaseous hydrogen fuel using the plurality of heat exchangers; determining a temperature of the gaseous hydrogen fuel; supplying the gaseous hydrogen fuel to a fuel cell based on the temperature of the gaseous hydrogen fuel being greater than or equal to a temperature threshold; and supplying the gaseous hydrogen fuel to a combustor of the gas turbine engine based on the temperature of the gaseous hydrogen fuel being less than the temperature threshold.

The method of any preceding clause, wherein the temperature threshold is greater than or equal to 500° C. and less than or equal to 1000° C.

The method of any preceding clause, further comprising: supplying a fuel-water mixture from the fuel cell to a fuel-water separator, the fuel-water mixture including an excess of the gaseous hydrogen fuel and water; separating the excess of the gaseous hydrogen fuel from the water; and supplying the excess of the gaseous hydrogen fuel to the combustor.

The method of any preceding clause, further comprising heating the gaseous hydrogen fuel using a recuperator before supplying the gaseous hydrogen fuel to the fuel cell.

The method of any preceding clause, further comprising heating the gaseous hydrogen fuel using an electric heater before supplying the gaseous hydrogen fuel to the combustor.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A fuel system for a gas turbine engine including a compressor section, a combustion section, and a turbine section, the fuel system comprising:
a fuel tank for storing a fuel;
a plurality of heat exchangers downstream of the fuel tank;
a valve downstream of the plurality of heat exchangers, the valve including a fuel inlet in fluid communication with the plurality of heat exchangers, a first fuel outlet in fluid communication with a first fluid pathway, and a second fuel outlet in fluid communication with a second fluid pathway;
a fuel cell including an anode inlet and an anode outlet, the anode inlet in fluid communication with the first fluid pathway;
a combustion chamber of the combustion section in fluid communication with the second fluid pathway and the anode outlet of the fuel cell; and
a controller communicatively coupled to the valve and configured to generate a valve command signal for the valve for selectively controlling an amount of the fuel delivered to the first fluid pathway, the second fluid pathway, or both the first fluid pathway and the second fluid pathway based on a temperature of the fuel.

2. The fuel system of claim 1, wherein the controller is communicatively coupled to the plurality of heat exchangers and configured to control a flowrate of fluid through the plurality of heat exchangers.

3. The fuel system of claim 1, further comprising:
at least one temperature sensor disposed in the first fluid pathway and communicatively coupled to the controller, the at least one temperature sensor configured to measure the temperature of the fuel;
wherein the controller is configured to generate the valve command signal based on the temperature of the fuel measured by the at least one temperature sensor.

4. The fuel system of claim 1, wherein the valve command signal comprises:
opening the first fuel outlet of the valve and directing at least a portion of the fuel to the fuel cell in response to the temperature of the fuel being greater than or equal to a temperature threshold; and
opening the second fuel outlet of the valve and directing at least a portion of the fuel to the combustion chamber in response to the temperature of the fuel being less than the temperature threshold.

5. The fuel system of claim 4, wherein the temperature threshold is greater than or equal to 500° C. and less than or equal to 1000° C.

6. The fuel system of claim 1, further comprising:
a third fluid pathway between the anode outlet of the fuel cell and the combustion chamber; and
a first recuperator including a first fuel passage in fluid communication with the first fluid pathway and a second fuel passage in fluid communication with the third fluid pathway;
wherein the first recuperator is configured to heat the fuel in the first fuel passage using excess fuel received by the second fuel passage from the anode outlet.

7. The fuel system of claim 6, further comprising:
a secondary valve disposed in the third fluid pathway between the anode outlet of the fuel cell and the second fuel passage of the first recuperator;
wherein the secondary valve is configured to control an amount of the excess fuel delivered to the second fuel passage of the first recuperator from the fuel cell.

8. The fuel system of claim 1, wherein the fuel cell comprises:
a cathode inlet in fluid communication with the compressor section via a fourth fluid pathway; and
a cathode outlet in fluid communication with the combustion chamber via a fifth fluid pathway;
wherein the fuel cell is configured to receive air from the compressor section via the cathode inlet; and
wherein the combustion chamber is configured to receive excess air from the cathode outlet.

9. The fuel system of claim 8, further comprising at least one temperature sensor disposed in the fourth fluid pathway and communicatively coupled to the controller, the at least one temperature sensor configured to measure a temperature of air received from the compressor section.

10. The fuel system of claim 9, further comprising:
at least one valve disposed in the fourth fluid pathway, the at least one valve downstream of the compressor section and upstream of the fuel cell, wherein the at least one valve is configured to control an amount of the air delivered to the fuel cell;
wherein the controller is configured to generate a valve command signal based on the temperature of the air measured by the at least one temperature sensor disposed in the fourth fluid pathway.

11. The fuel system of claim 8, further comprising:
a second recuperator including a first fluid passage in fluid communication with the fourth fluid pathway and a second fluid passage in fluid communication with the fifth fluid pathway;
wherein the first fluid passage of the second recuperator is in fluid communication with the compressor section and the cathode inlet of the fuel cell;
wherein the second fluid passage of the second recuperator is in fluid communication with the cathode outlet and the combustion chamber; and
wherein the second recuperator is configured to heat the air in the first fluid passage received from the compressor section using heat from the excess air received by the second fluid passage from the cathode outlet.

12. The fuel system of claim 1, further comprising:
at least one electric heater upstream of the fuel cell and the combustion chamber;
wherein the electric heater is configured to heat the fuel supplied to the fuel cell, the combustion chamber, or both the fuel cell and the combustion chamber.

13. The fuel system of claim 12, wherein the at least one electric heater is disposed in the second fluid pathway for heating the fuel supplied to the combustion chamber.

14. The fuel system of claim 12, wherein the at least one electric heater is disposed in the first fluid pathway for heating the fuel supplied to the fuel cell during a cold start-up process of the gas turbine engine.

15. The fuel system of claim 14, further comprising:
an exhaust-gas heat exchanger downstream of the at least one electric heater;
wherein the exhaust-gas heat exchanger is configured to heat the fuel when the gas turbine engine is no longer in the cold start-up process; and
wherein the controller is configured to control a flow rate of exhaust gas through the exhaust-gas heat exchanger.

16. The fuel system of claim 12, wherein:
the controller is communicatively coupled to the at least one electric heater; and
the controller is configured to generate a heater signal for regulating power delivered to the at least one electric heater.

17. The fuel system of claim 1, further comprising:
a condenser in fluid communication with the combustion chamber and an exhaust nozzle of the gas turbine engine;
wherein the condenser is configured to reduce water content in exhaust gas received from the combustion chamber and reduce contrail formation.

18. The fuel system of claim 17, wherein:
the condenser includes a liquid outlet fluidly coupled to the combustion chamber for reducing nitrogen oxides;
the liquid outlet of the condenser is fluidly coupled to the turbine section for turbine cooling; and
the liquid outlet of the condenser is fluidly coupled to a water treatment and storage system of the gas turbine engine.

19. The fuel system of claim 1, further comprising:
a fuel-water separator in fluid communication with the anode outlet of the fuel cell and the combustion chamber;
wherein the fuel-water separator is configured to separate water from excess fuel discharged from the anode outlet the fuel cell;
wherein the excess fuel is delivered to the combustion chamber; and
wherein the water is delivered to the turbine section, a water treatment and storage system of the gas turbine engine, or a combination thereof.

20. A gas turbine engine, comprising:
a fan;
a turbomachine operably coupled to the fan for driving the fan, the turbomachine comprising a compressor section, a combustion section, and a turbine section in serial flow order and together defining a working gas flow path; and
the fuel system of claim 1.
